(19) United States
(12) Patent Application Publication
(10) Pub. No.: US 2013/0007586 A1
(43) Pub. Date: Jan. 3, 2013

(54) Method and system for creating and using web feed display templates

(76) Inventor: Renjit Tom THOMAS, Vancouver, WA (US)

(21) Appl. No.: 13/135,228

(22) Filed: Jun. 29, 2011

(51) Int. Cl. G06F 17/00

(52) U.S. Cl. 715/234

(57) ABSTRACT

Web feed display templates are created and used to reduce the time and cost to conform web feeds to device constraints and content provider display guidelines. A web feed display template is customized for a particular type of device and a particular web feed. The display template is created by administrative input of values for predefined display parameters. The values are selected to conform the web feed to the constraints of the device and content provider display guidelines for the web feed. When a user of the device subscribes to the web feed, the display template is used to dynamically create web pages containing web feed items that conform to the constraints of the device and the content provider display guidelines.

### BACKGROUND OF THE INVENTION

The present invention relates to web content presentation and, more particularly, to display of web feeds on embedded devices.

Many content provider (CP) websites offer topic-driven web feeds. Once a user subscribes to a web feed, a CP server sends items in the web feed to the user's device. Once the web feed items arrive at the user's device, the web feed items are often displayed on web pages within the device's web browser.

Many web feed items are formatted as Really Simple Syndication (RSS) documents. As is known, an RSS document includes Extensible Markup Language (XML) fields such as the author of the content, the publication date, a succinct summary of a news article, images and a hyperlink to the complete article.

Web pages containing web feed items have typically been rendered by a standard reader (e.g., standard RSS reader) in a standard browser on the device. Using a standard reader to render the web pages containing web feed items works fine where the device has a large display screen and substantial processing and memory resources. However, where a device has limited screen size, processing and/or memory limitations, as is true of many embedded devices, customization in creating such web pages is sometimes required. For example, a web feed item includes an article summary and a hyperlink to the full article. Yet an embedded device may have insufficient memory to render the full article if the hyperlink is activated. Thus, a customization may be needed when creating a web page containing the web feed item to remove the hyperlink. As another example, a CP may require that its logo be displayed as a bullet point before each web feed item. Yet an embedded device may lack the screen “real estate” needed to display the logo when rendering a web page containing web feed items created by a standard reader. Thus, a customization may be required when creating a web page containing web feed items to ensure the logo will be in a viewable position.

Customizations made to conform web feeds to device constraints and CP display guidelines have historically required a software development effort. That is, a software developer has been engaged to write custom code that renders the web feed in a manner that is compatible with the device type and the CP display guidelines. These software development efforts have consumed substantial time and resources.

### SUMMARY OF THE INVENTION

The present invention reduces the time and cost to conform web feeds to device constraints and CP display guidelines through the expedient of web feed display templates. A web feed display template is customized for a particular type of device and a particular web feed. The display template is created by administrative input of values for predefined display parameters. The values are selected to conform the web feed to the constraints of the device and CP display guidelines for the web feed. When a user of the device subscribes to the web feed, the display template is used to dynamically create web pages containing web feed items that conform to the constraints of the device and the CP display guidelines. The web feed display template paradigm of the present invention obviates the need for software development to conform web feeds to device constraints and CP display guidelines and allows device administrators who lack coding experience to add support for new web feeds to their devices.

In one aspect of the invention, a method for rendering web feeds on a device in a manner that conforms to device constraints and content provider display guidelines comprises the steps of receiving values for predefined display parameters for each of a multiple of web feeds; creating a display template for each of the multiple of web feeds using the values received for the respective web feeds; receiving a subscription request for one of the web feeds from a device; receiving items in the requested one of the web feeds in response to the subscription request; creating web pages containing the items using the display template for the requested one of the web feeds; and transmitting the web pages to the device.

In some embodiments, the method further comprises creating a top page containing a selectable subscription icon for each of the multiple of web feeds using the display templates and transmitting the top page to the device, wherein the subscription request is received in response to selection on the device of one of the subscription icons.

In some embodiments, the web pages are further created using a Cascading Style Sheet (CSS) file.

In some embodiments, the display parameters comprise a Uniform Resource Locator (URL) of a web feed.

In some embodiments, the display parameters comprise a maximum number of items per web page for a web feed.

In some embodiments, the display parameters comprise an indication of whether to allow navigation between web pages of a web feed each of which contains a subset of the total number of items of the web feed.

In some embodiments, the display parameters comprise an indication of whether to strip character data (CDATA) tags from items of a web feed.

In some embodiments, the display parameters comprise an indication of whether to strip Hypertext Markup Language (HTML) tags from items of a web feed.

In some embodiments, the display parameters comprise an indication of whether to convert text in items of a web feed to an image.

In some embodiments, the display parameters comprise an indication of whether to allow scrolling across web pages of a web feed.

In some embodiments, the display parameters comprise an indication of which image URLs to support in items of a web feed.

In some embodiments, the display parameters comprise an indication of which image namespaces to support in items of a web feed.

In some embodiments, the device is an embedded device.

In some embodiments, the creating step comprises associating with the web pages a server request methodology for navigating between items contained in the web pages.

In some embodiments, the creating step comprises associating with the web pages a Javascript methodology for navigating between items contained in the web pages.

In some embodiments, the creating step comprises associating with the web pages a hybrid server request/Javascript methodology for navigating between items contained in the web pages.

In some embodiments, the creating step comprises extracting image URLs from the received items and importing images retrieved using the image URLs into the web pages.

In another aspect of the invention, a device server comprises at least one administrative interface; at least one network interface; and at least one processor communicatively coupled with the administrative interface and the network interface, wherein the device server receives via an administrative interface values for predefined display parameters for each of a multiple of web feeds, wherein the device server under control of the processor creates a display template for each of the multiple of web feeds using the values received for the respective web feeds, wherein the device server receives via a network interface a subscription request for one of the web feeds from a device, wherein the device server receives via a network interface items in the requested one of the web feeds in response to the subscription request, wherein the device server under control of the processor creates web pages containing the items using the display template for the requested one of the web feeds and wherein the device server transmits via a network interface the created web pages to the device.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a web feed delivery system in some embodiments of the invention.

FIG. 2 shows a device server in some embodiments of the invention.

FIG. 3 shows device server elements in some embodiments of the invention.

FIG. 4 shows elements of a web feed display template in some embodiments of the invention.

FIG. 5 shows exemplary pseudocode for parsing web feed items and collecting the field contents of web feed items as objects.

FIG. 6 shows exemplary place holder HTML pseudocode for a web page which will be filled with web feed items by a device server.

FIG. 7 shows exemplary place holder HTML pseudocode for a web page which will be filled with web feed items and navigation buttons created by a device server, for use where actions associated with the navigation buttons are executed by a Javascript method.

FIG. 8 shows exemplary place holder HTML pseudocode for a web page which will be filled with web feed items and navigation buttons created by a device server, for use where actions associated with the navigation buttons are executed by a server request method.

FIG. 9 shows exemplary XML pseudocode for web feed items created by a device server, for use where actions associated with navigation buttons are executed by a hybrid server request/Javascript method.

FIG. 10 shows a web feed item containing an image URL specified using a first specification method.

FIG. 11 shows a web feed item containing an image URL specified using a second specification method.

FIG. 12 shows a web feed item containing an image URL specified using a third specification method.

FIGS. 13A-13C show exemplary pseudocode for extracting image URLs from web feed items.

FIG. 14 shows a method for creating and using a web feed display template in some embodiments of the invention.

### DETAILED DESCRIPTION OF A PREFERRED EMBODIMENT

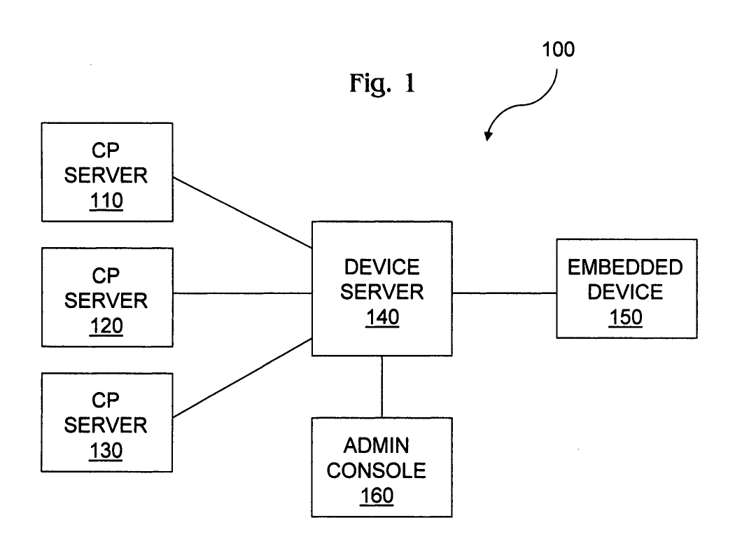

FIG. 1 shows a web feed delivery system 100 in some embodiments of the invention. Delivery system 100 includes a multiple of CP servers 110, 120, 130 at the head-end, an embedded device 150 at the tail-end and a device server 140 in between. CP servers 110, 120, 130, device server 140 and embedded device 150 are communicatively coupled over wired and/or wireless connections using well-known networking protocols, such as TCP/IP. CP servers 110, 120, 130 are web servers that each offer one or more web feeds to web client devices in accordance with CP display guidelines. Embedded device 150 is an embedded web client device that subscribes to one or more of the web feeds, resulting in items in the web feeds being delivered from one or more of CP servers 110, 120, 130 and displayed on embedded device 150 in accordance with CP display guidelines. Device server 140 is a server, such as a proxy server, that conforms web feeds received from CP servers 110, 120, 130 to constraints of embedded device 150, such as screen, processing and memory limitations, as well as CP display guidelines. Conformance is realized through the expedient of web feed display templates customized for particular web feeds and the particular type of embedded device 150. Administration console 160 is a management console invoked by a device administrator in the creation of web feed display templates. Administration console 160 has a user input/output mechanism, such as a display screen and a keyboard and computer mouse, for receiving/displaying information to a device administrator, allowing the device administrator to input values for display parameters required to create web feed templates and thereby add support for new web feeds to embedded device 150, and other devices (not shown) in delivery system 100 that are of the same type as embedded device 150.

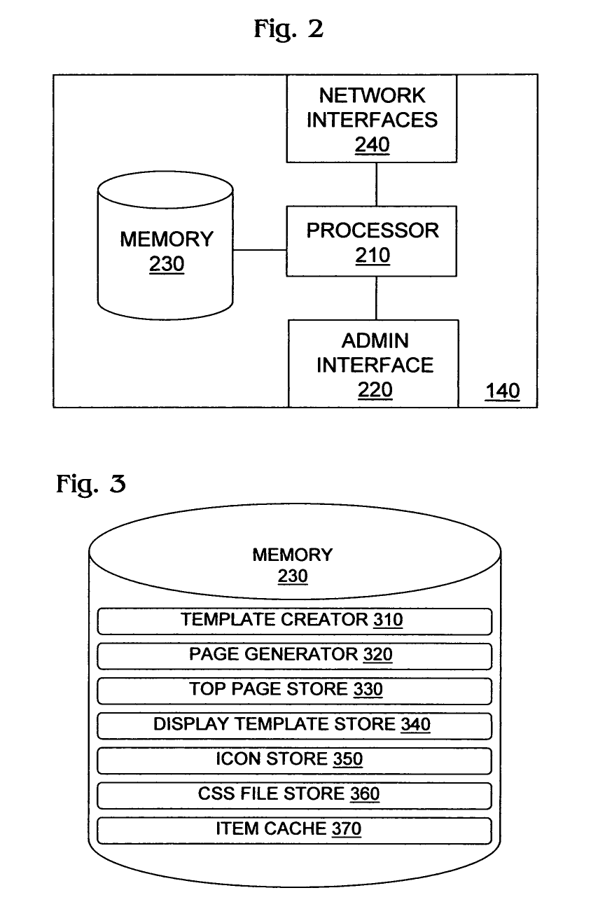

FIG. 2 shows device server 140 in some embodiments of the invention to include a processor 210 communicatively coupled between an administration interface 220, a memory 230 and one or more network interfaces 240. In some embodiments, processor 210 performs the functions attributed to processor 210 herein by executing software modules stored in memory 230, although in other embodiments a processor may perform such functions in various combinations of software modules and custom logic.

FIG. 3 shows elements of device server 140 stored in memory 230 in some embodiments of the invention to include a template creator 310, a page generator 320, a top page store 330, a display template store 340, an icon store 350, a CSS file store 360 and an item cache 370.

Template creator 310 is a software module executed by processor 210 that creates display templates. Each display template is customized for a particular type of device and a particular web feed. That is, each display template conforms a web feed to constraints of a particular device type (e.g., manufacturer and model) and particular CP display guidelines for the web feed. In the illustrated embodiment, template creator 310 creates display templates that conform different web feeds to constraints of embedded device 150.

Template creator 310 transmits template creation user screens to administration console 160 via administration interface 220 and receives inputs inputted by a device administrator on the user screens. The inputs may be made into HTML forms sent to administration console 160 and displayed in a web browser on administration console 160. For each web feed, the administrator inputs values for predefined display parameters that conform the web feed to embedded device 150.

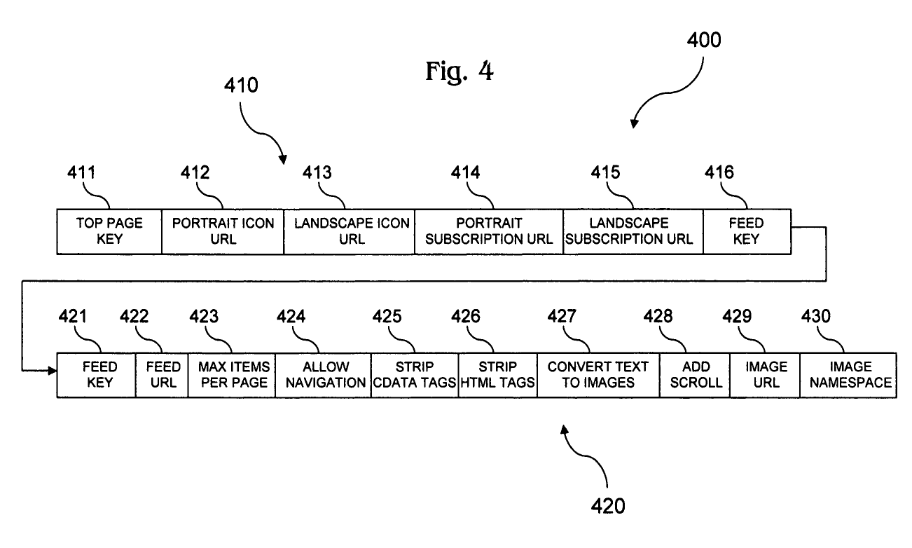

An exemplary display template 400 is shown in FIG. 4. The display template includes values for top page display parameters 410 and values for feed display parameters 420. Top page display parameters 410 include a top page key 411, a portrait icon URL 412, a landscape icon URL 413, a portrait subscription URL 414, a landscape subscription URL 415 and a web feed key 416. Feed display parameters 420 include a web feed key 421, a web feed URL 422, a maximum number of items per web page for the web feed 423, a navigation indicator 424 indicating whether to allow navigation between web pages of the web feed, a strip CDATA indicator 425 indicating whether to strip CDATA tags from items of the web feed, a strip HTML tag indicator 426 indicating whether to strip HTML tags from items of the web feed, a text/image conversion indicator 427 indicating whether to convert text in items of the web feed to an image, a scroll indicator 428 indicating whether to allow scrolling across web pages of the web feed, an image URL indicator 429 indicating which image URLs to support in items of the web feed and an image namespace indicator 429 indicating which image namespaces to support in items of the web feed. Template creator 310 creates a display template for each web feed using values inputted for each of these predefined display parameters and stores the display templates in display template store 340.

In other embodiments, administration console 160 may have template creation client software stored and executed thereon that interoperates with template creator 310. In these embodiments, the template creation client software receives as inputs values for predefined display parameters for web feeds and transmits the values to device server 140 whereupon template creator 310 creates display templates for the web feeds using the values.

Page generator 320 is a software module that creates web pages using the display templates created by template creator 310. Page generator 320 retrieves the portrait icon URLs and portrait subscription URLs from the display templates for all web feeds and creates a portrait mode top page. Page generator 320 retrieves the landscape icon URLs and landscape subscription URLs from the display templates for all web feeds and creates a landscape mode top page. Page generator 320 renders the portrait mode top page on embedded device 150 when a web browser is launched on embedded device 150 while device 150 is in the portrait mode (as determined from an accelerometer on embedded device 150 and communicated to device server 140). Page generator 320 renders the landscape mode top page on embedded device 150 when the web browser is launched on embedded device 150 while device 150 is in the landscape mode. More particularly, page generator 320 uses the icon URLs in the display templates to retrieve icons that represent the web feeds and creates top pages containing the icons as selectable icons that when selected by a user of embedded device 150 cause a subscription request including a subscription URL for a web feed associated with the selected icon to be returned to page generator 320. Page generator 320 stores the top pages in top page store 330 and updates the top pages whenever the device administrator creates a new display template to support a new web feed on embedded device 150.

In some embodiments, the icon URLs from the display templates are used to retrieve icons from local storage on device server 140. For example, a portrait icon URL styled http://ds/cp1/icon-P in a display template created for a web feed cp1 offered by a content provider may identify a portrait icon icon-P stored locally on device server ds 140 in icon store 350, whereas a landscape icon URL styled http://ds/cp1/icon-L in a display template created for a web feed cp1 offered by content provider may identify a landscape icon icon-L stored locally on device server ds 140 in icon store 350. A portrait subscription URL for such a web feed may be styled http://ds/cp1/url-P and a landscape subscription URL for such a web feed may be styled http://ds/cp1/url_L, by way of example.

In other embodiments, the icon URLs from the display templates are used to retrieve icons from remote storage on the content servers 110, 120, 130 that offer the web feeds. For example, a portrait icon URL styled http://cp1/icon-P in a display template created for a web feed cp1 offered by a content provider may identify a portrait icon icon-P stored on content server 110, whereas a landscape icon URL styled http://cp1/icon-L in a display template created for a web feed cp1 offered by a content provider may identify a landscape icon icon-L stored on content server 110. A portrait subscription URL for such a web feed may be styled http://cp1/url-P and a landscape subscription URL value for such a web feed may be styled http://cp1/url_L, by way of example.

Page generator 320 pulls web feeds from the content servers 110,120, 130 that offer the web feeds in response to subscription requests received from embedded device 150. In response to rendering a top page on embedded device 150, page generator 320 receives from embedded device 150 via one of network interfaces 240 a subscription request including a subscription URL for one of the web feeds offered by one of CP servers 110, 120, 130. In response to the subscription request, page generator 320 pulls the web feed from the one of CP servers 110, 120, 130 that offers the web feed corresponding to the subscription URL using the feed URL for the web feed. For example, upon receiving a subscription request including the portrait subscription URL http://ds/cp1/URL-P, page generator 320 identifies a matching portrait subscription URL http://ds/cp1/URL-P in a display template and retrieves from the same display template a feed key Feed1. Page generator 320 uses the feed key Feed1 as an index into the feed display parameters of the display template and retrieves the feed URL http://cp1/feed1-URL. Page generator 320 then sends a subscription request including the feed URL http://cp1/feed1-URL to the one of the CP servers 110, 120, 130 that offers the web feed, resulting in the return from the one of CP servers 110, 120, 130 of items in the web feed.

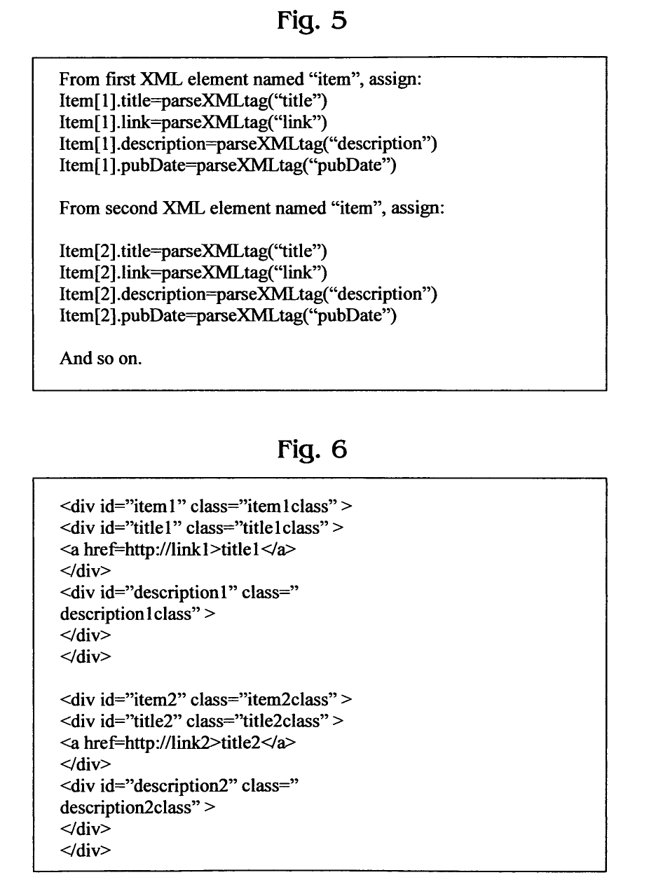

The web feed items returned in response to subscription requests are RSS documents that each include the XML fields <title>, <link>, <description> and <pubDate> (publication date). Page generator 320 parses the returned items and collects the field contents as objects. FIG. 5 shows exemplary pseudocode for parsing web feed items and collecting the field contents of web feed items as objects. The collected objects are stored in item cache 370.

Page generator 320 may limit the scope of returned web feed items based on contents of item cache 370. For example, page generator 320 may specify in a subscription request that only items published after the most recent publication date of an item in item cache 370 should be returned. Moreover, page generator 320 may specify in the subscription request that no more than a defined number of items should be returned due to current memory constraints in item cache 370.

Page generator 320 creates web pages containing returned web feed items using the display template created for the web feed. Page generator 320 applies values for feed display parameters within the display template to the returned items to create web pages that conform to constraints of embedded device 150 and CP display guidelines applicable to the web feed.

Page generator 320 retrieves from CSS file store 360 and attaches the CSS file corresponding to the present orientation of embedded device 150 to stylize the web pages in terms of layout, font, colors, etc. Page generator 320 transmits the web pages to embedded device 150 via one of network interfaces 240. The CSS files stored in CSS file store 360 may either be supplied by the CP or created by a graphics designer using guidelines supplied by the CP.

Specific application of values for feed display parameters in the creation of web pages containing returned web feed items will now be discussed.

Consider first application of maximum items per page 423 and navigation indicator 424 display parameters to four returned web feed items to be displayed to a user on embedded device 150 while in landscape mode. More specifically, consider an example where the maximum items per page value in the display template for the web feed is set to “2” and the navigation indicator value in the display template for the web feed is set to “false” (i.e., navigation not allowed). In that event, page generator 320 dynamically creates a web page containing the first two items as shown in FIG. 6. Note that the web page does not show the second two items and does not have means to navigate between web pages. Page generator 320 attaches the CSS file that defines the layout, font, colors, CP display guidelines, device display constraints, etc. for item1class, title1class, description1class, item2class and title2class and description2class and sends the web page to embedded device 150 via one of network interfaces 240.

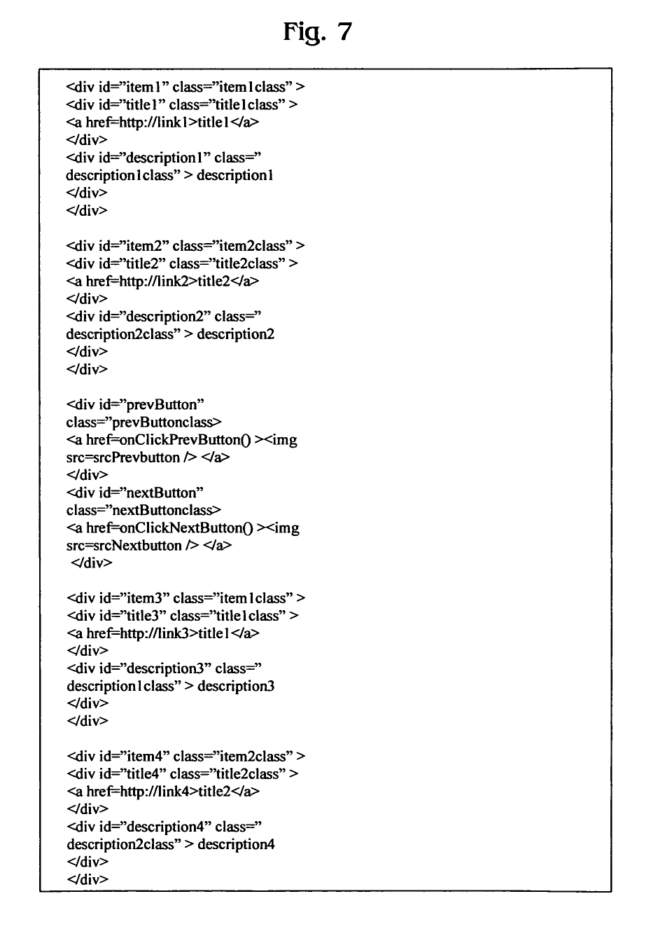

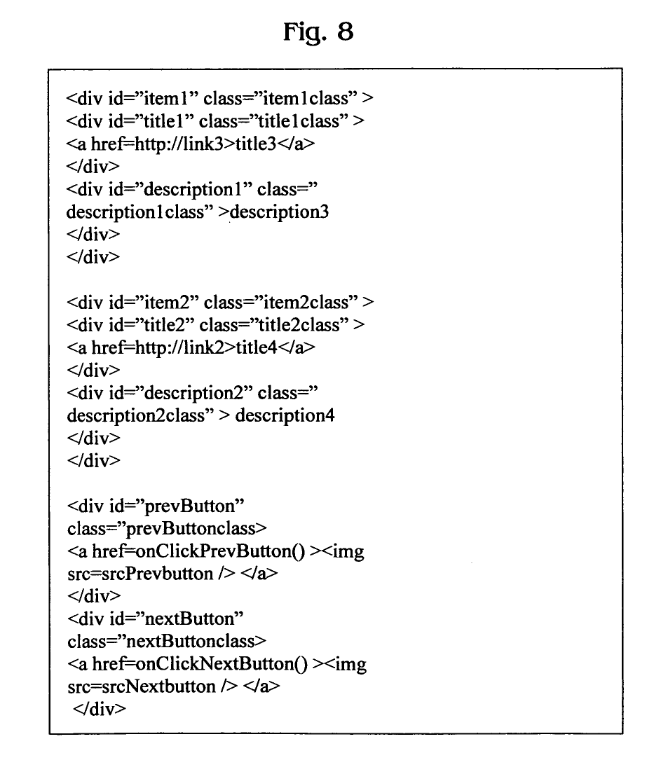

Next consider an example where the maximum items per page value in the display template for the web feed is set to “2”, the navigation indicator in the display template is set to “true” (i.e., navigation allowed) and page generator 320 is configured to associate a Javascript methodology with web pages to navigate between items. In that event, page generator 320 dynamically creates a web page containing all four items as shown in FIG. 7. Note that in this example, the web page includes the first two items followed by the navigation buttons followed by the second two items. Page generator 320 attaches the CSS file that defines the layout, font, colors, CP display guidelines, device display constraints, etc. for item1class, title1class, description1class, item2class, title2class and description2class and transmits the web page to embedded device 150 via one of network interfaces 240. Moreover, when the web page is sent to embedded device 150, the web page is accompanied by a Javascript (.js) file that hides selected items and contains script action for the navigation buttons. Thus, when the web page is initially displayed, the Javascript file displays the first two items and the navigation buttons but hides the second two items from view. When a user on embedded device 150 presses nextButton from the initially displayed web page, the Javascript file displays the second two items and the navigation buttons but hides the first two items from view.

Next consider an example where the maximum items per page value in the display template for the web feed is set to “2”, the navigation indicator value in the display template is set to “true” (i.e., navigation allowed) and page generator 320 is configured to associate a server request methodology with web pages to navigate between items. In that event, page generator 320 dynamically creates a web page containing the first two items as shown in FIG. 8. Page generator 320 attaches the CSS file that defines the layout, font, colors, CP display guidelines, device display constraints, etc. for item1class, title1class, description1class, item2class, title2class and description2class and transmits the web page to embedded device 150 via one of network interfaces 240. Note that in this example, the web page includes the first two items followed by the navigation buttons. When a user on embedded device presses nextButton from the initially displayed web page, a server request (e.g., http://cp1/feed1-URL?page=2) is sent to server device 140 and page generator 320 dynamically creates and returns a second web page that includes the second two items followed by the navigation buttons.

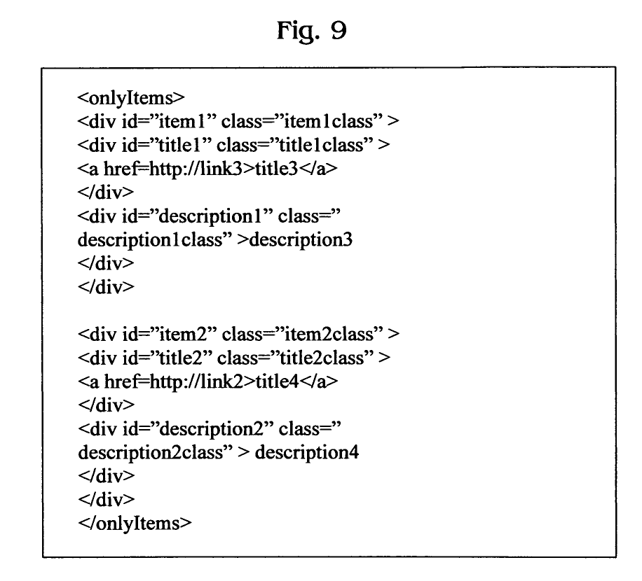

Finally, consider an example where the maximum items per page value in the display template for the web feed is set to “2”, the navigation indicator value in the display template is set to “true” (i.e., navigation allowed) and page generator 320 is configured to associate a hybrid server request/Javascript methodology with web pages to navigate between items. In that event, page generator 320 initially dynamically creates a web page containing the first two items as shown in FIG. 8. Page generator 320 attaches the CSS file that defines the layout, font, colors, CP display guidelines, device display constraints, etc. for item1class, title1class, description1class, item2class, title2class and description2class and transmits the web page to embedded device 150 via one of network interfaces 240. Note that in this example, the web page includes the first two items followed by the navigation buttons. When a user on embedded device presses nextButton from the web page, an “onlyItems” server request (e.g., http://cp1/feed1-URL?page=2&onlyItems) is sent to server device 140 directing page generator 320 to dynamically create and return the “onlyItems” XML pseudocode shown in FIG. 9 having only the second two items. Upon receiving the “onlyItems” XML pseudocode, the Javascript file (using an AJAX call) parses out the “onlyItems” tag, cuts the first two items from the web page and pastes the newly parsed second two items into the web page. This hybrid methodology uses less memory on embedded device 150 than the Javascript method and is generally faster than the server request method. This hybrid method is also visually smoother when the new items are brought into the display on embedded device 150.

Next consider application of strip CDATA tag indicator 425 and strip HTML tag indicator 426 in the creation of web pages containing returned web feed items. If indicators 425, 426 are set to “true”, page generator 320 removes CDATA tags and HTML tags from returned web feed items using regular expressions to render web links (e.g., URLs) on web pages containing web feed items non-clickable by the user of embedded device 150. Tag removal may be desired, for example, if embedded device 150 does not have sufficient memory to store content linked by tags, or does not have plugins required to view such content, or if such content is not approved by the administrator. Naturally, indicators 425, 426 are individually settable by the device administrator so that CDATA tags may be removed while HTML tags may be retained, or vice versa, if desired. In some embodiments, page generator 320 sends web links removed from web feed items to an email inbox or website where the removed links can be viewed by the user of embedded device 150 from a more capable device, such as a personal computer.

Next consider application of text/image conversion indicator 427 in the creation of web pages containing returned web feed items. If indicator 427 is set to “true”, text in web pages containing web feed items is converted to images. Text-to-image conversion may be desired, for example, if embedded device 150 has limited font support or a tendency to render images faster than text.

Next consider application of scroll indicator 428 in the creation of web pages containing returned web feed items. If indicator 428 is set to “true”, text and images in web feed items are made scrollable. Scrollability may be desired, for example, if embedded device 150 has limited screen real estate and cannot fit the complete text or image on-screen at one time.

Sometimes web feed items include image URLs of images to be displayed in the web feed items. Page generator 320 locates and extracts image URLs specified using popular image specifications (three of which are shown by way of example), retrieves images using the image URLs and displays these images in the web feed items. Moreover, when a new, future, image URL schema specification is introduced, the administrator will be able to add the schema without any code rewrite.

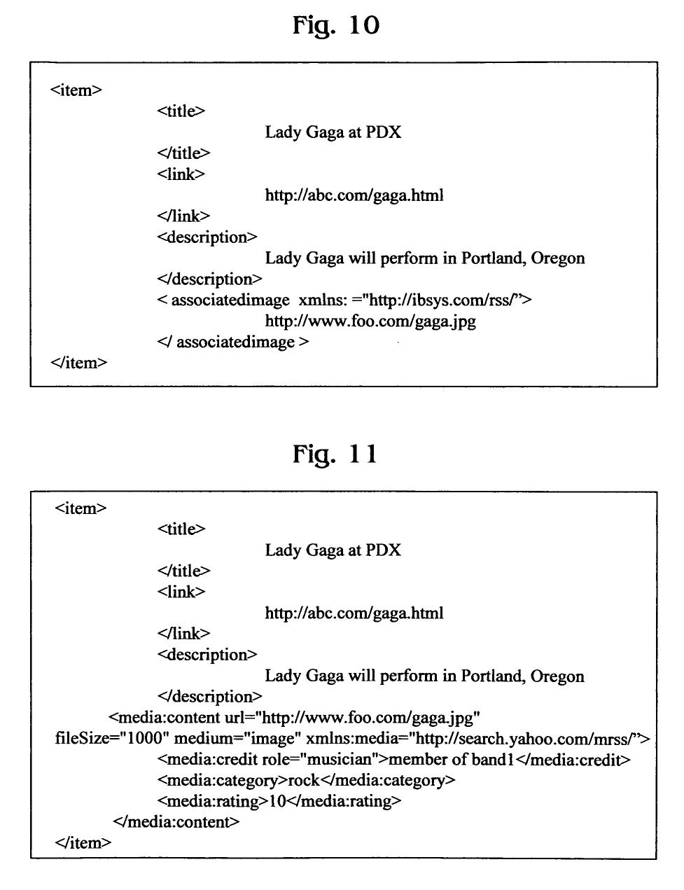

First, page generator 320 searches image URLs specified according to the schema of image in the namespace http://www.ibsys.com/rss/. These image URLs are embedded in the tag <associatedimage>. By way of example, FIG. 10 shows the image URL http://www.foo.com/gaga.jpg embedded according to the schema of http://www.ibsys.com/rss/ in a web feed item entitled “Lady Gaga at PDX”. In this case, page generator 320 looks for the content of the tag <associatedimage> in the respective namespace and finds the image URL http://www.foo.com/gaga.jpg embedded therein.

Second, page generator 320 searches for image URLs specified according to the schema of namespace http://search.yahoo.com/mrss/ (denoted as namespace “media” in subsequent sentences) where the image URL is embedded in the tag <media:content url=“imageURL” medium=“image”/>. For example, FIG. 11 shows the image URL http://www.foo.com/gaga.jpg embedded in such a tag according to the schema of http://search.yahoo.com/mrss/ in a web feed item entitled Lady Gaga at PDX.” In this case, page generator 320 looks for tag <media:content> and parses the attribute url since the value of the attribute medium is image. Upon parsing the attribute url, page generator 320 finds the image URL http://www.foo.com/gaga.jpg.

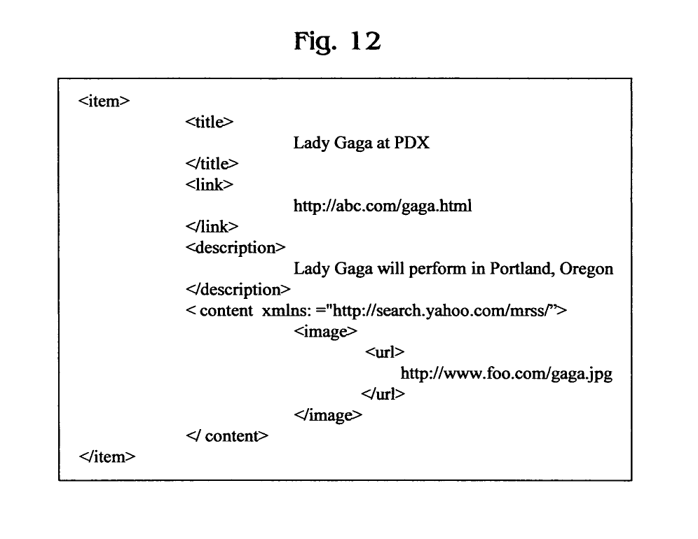

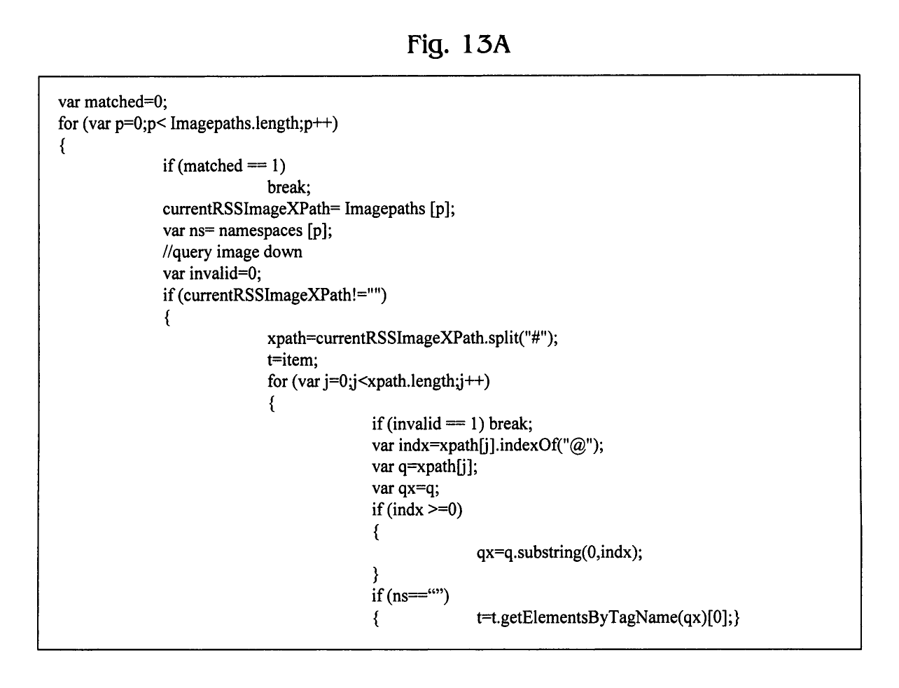

Third, page generator 320 searches for image URLs specified according to the schema of namespace http://search.yahoo.com/mrss/ where the image URL is embedded in the tag cascade <content><image><url>. For example, FIG. 12 shows the image URL http://www.foo.com/gaga.jpg embedded in such a tag cascade according to the schema of http://search.yahoo.com/mrss/ in a web feed item entitled “Lady Gaga at PDX.” In this case, page generator 320 looks for the content of the XML tag cascade <content><image><url> and finds the image URL http://www.foo.com/gaga.jpg.

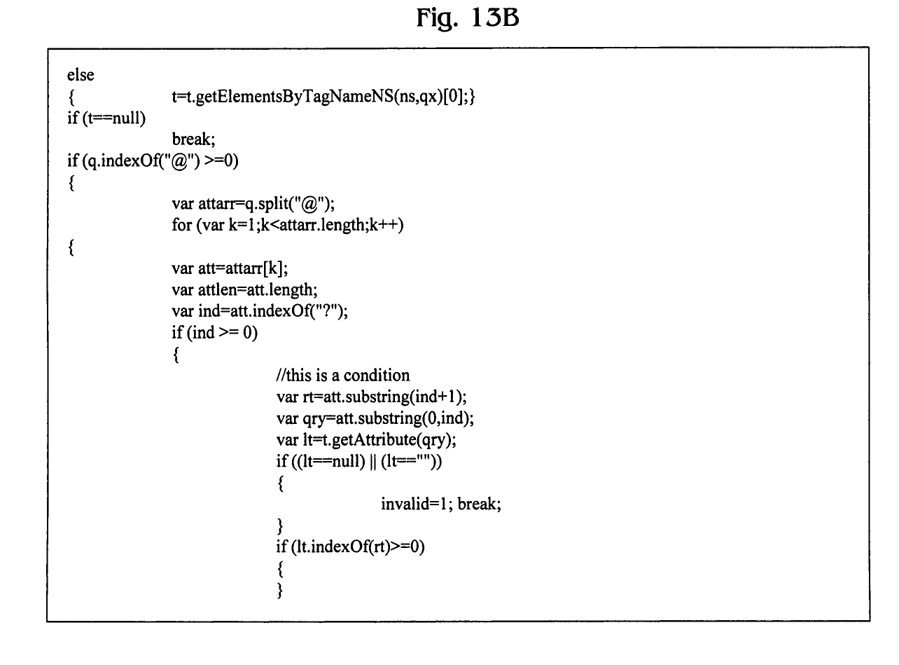

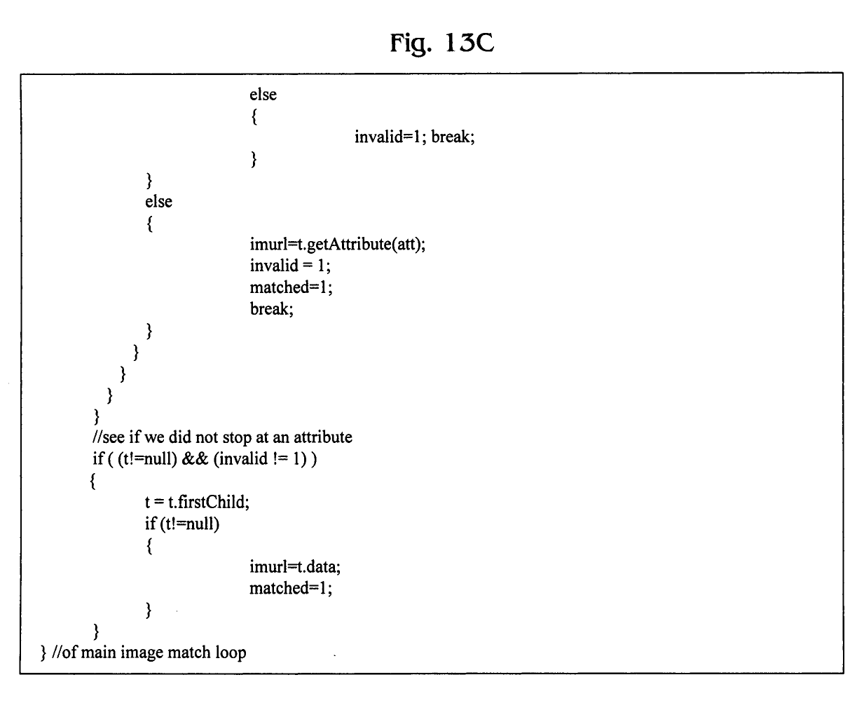

Page generator 320 extracts the image URLs by executing pseudocode shown in FIGS. 13A-13C (where the code in FIG. 13B follows the code in FIG. 13A and the code in FIG. 13C follows the code in FIG. 13B), using the following compact representation of the relevant namespaces and imagepaths as inputs:

namespaces{ }=
http://www.ibsys.com/rss,
http://search.yahoo.com/mrss/,
http://search.yahoo.com/mrss/
Imagepaths{ }=
associatedimage,
content@medium?image@url,
content#image#url

In the compact representation, @ denotes an attribute, ? denotes a condition and # denotes a tag cascade. Thus, content@medium?image@url denotes that an image URL can be retrieved from attribute url if the value of medium within the element content is image. Moreover, content#image#url denotes to look for an image URL within the tag cascade <content><image><url>.

Now consider image URL 428 and image namespace 429 in the creation of web pages containing returned web feed items. The values of image URL 428 and image namespace 429 are used as filters that limit which image URLs page generator 320 will search for and extract from web feed items. More particularly, page generator 320 will not search for image URLs that are specified according to an image namespace not listed in image namespace 429 and will ignore image URLs that are not listed in image URL 428. However, image URL 428 and/or image namespace 429 may be set to “all”, which causes page generator 320 to search for all image URLs specified according to the three specifications discussed above. Naturally, when an administrator adds a new image URL specification, that URL will also be included in the definition of “all” from then on.

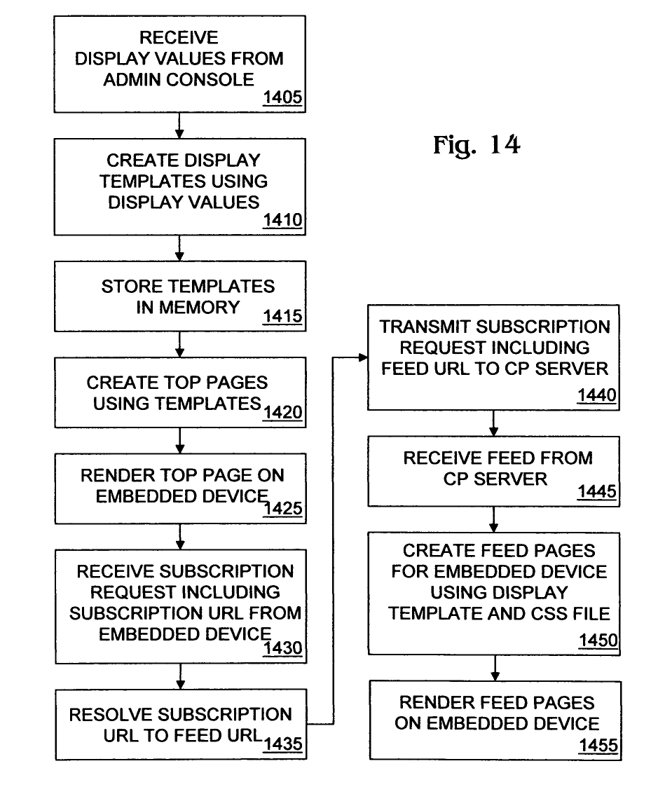

FIG. 14 shows a method for creating and using a web feed display template in some embodiments of the invention. The method is performed on device server 140. At the outset, device server 140 receives values for display parameters for a multiple of web feeds from administration console 160 (1405). Separately, device server 140 receives portrait and landscape mode icons and CSS files for the multiple of web feeds from the ones of CP servers 110, 120, 130 that support the web feeds. Next, device server 140 under the control of processor 210 creates a multiple of display templates for the multiple of web feeds using the received display parameter values (1410) and stores the display templates in memory 230 (1415). Next, device server 140 under control of processor 210 creates portrait and landscape mode top pages for embedded device 150 using the display templates (1420) and renders on embedded device 150 the top page that corresponds to the orientation of embedded device 150 (1425). The top page includes selectable icons for the multiple of web feeds. Next, in response to selection by a user of embedded device 150 of one of the selectable icons on the top page, device server 140 receives from embedded device 150 a subscription request including a subscription URL for one of the web feeds (1430). Next, device server 140 under control of processor 210 locates the display template that includes the subscription URL and fetches the corresponding feed URL for the web feed from the display template (1435). Next, device server 140 sends a subscription request including the feed URL to the one of CP servers 110, 120, 130 that offers the web feed (1440) and receives items in the web feed from the one of CP servers 110, 120, 130 (1545). Next, device server 140 under the control of processor 210 creates web pages containing the web feed items using the display template for the web feed and the CSS file that corresponds to the orientation of embedded device 150 (1450), and renders on embedded device 150 the web pages containing the web feed items (1455). Application of the display template and CSS file customized for the particular type of device and the particular web feed results conformance of the web pages displayed on embedded device 150 to constraints of embedded device 150 and CP display guidelines.

It will be appreciated by those of ordinary skill in the art that the invention can be embodied in other specific forms without departing from the spirit or essential character hereof. The present description is thus considered in all respects to be illustrative and not restrictive. The scope of the invention is indicated by the appended claims, and all changes that come with in the meaning and range of equivalents thereof are intended to be embraced therein.

What is claimed is:

1. A method for rendering web feeds on a device in a manner that conforms to device constraints and content provider display guidelines, comprising the steps of:
receiving values for predefined display parameters for each of a multiple of web feeds;
creating a display template for each of the multiple of web feeds using the values received for the respective web feeds;
receiving a subscription request for one of the web feeds from a device;
receiving items in the requested one of the web feeds in response to the subscription request;
creating web pages containing the items using the display template for the requested one of the web feeds; and
transmitting the web pages to the device.

2. The method of claim 1, further comprising the steps of:
creating a top page containing a selectable subscription icon for each of the multiple of web feeds using the display templates; and
transmitting the top page to the device, wherein the subscription request is received in response to selection on the device of one of the subscription icons.

3. The method of claim 1, wherein the web pages are further created using a Cascading Style Sheet file.

4. The method of claim 1, wherein the display parameters comprise a Uniform Resource Locator (URL) of a web feed.

5. The method of claim 1, wherein the display parameters comprise a maximum number of items per web page for a web feed.

6. The method of claim 1, wherein the display parameters comprise an indication of whether to allow navigation between web pages of a web feed each of which contains a subset of the total number of items of the web feed.

7. The method of claim 1, wherein the display parameters comprise an indication of whether to strip character data tags from items of a web feed.

8. The method of claim 1, wherein the display parameters comprise an indication of whether to strip Hypertext Markup Language tags from items of a web feed.

9. The method of claim 1, wherein the display parameters comprise an indication of whether to convert text in items of a web feed to an image.

10. The method of claim 1, wherein the display parameters comprise an indication of whether to allow scrolling across web pages of a web feed.

11. The method of claim 1, wherein the display parameters comprise an indication of which image URLs to support in items of a web feed.

12. The method of claim 1, wherein the display parameters comprise an indication of which image namespaces to support in items of a web feed.

13. The method of claim 1, wherein the device is an embedded device.

14. The method of claim 1, wherein the creating step comprises the substep of associating with the web pages a server request methodology for navigating between items contained in the web pages.

15. The method of claim 1, wherein the creating step comprises the substep of associating with the web pages a Javascript methodology for navigating between items contained in the web pages.

16. The method of claim 1, wherein the creating step comprises the substep of associating with the web pages a hybrid server request/Javascript methodology for navigating between items contained in the web pages.

17. The method of claim 1, wherein the creating step comprises the substeps of:
extracting image URLs from the received items; and
importing images retrieved using the image URLs into the web pages.

18. A device server, comprising:
at least one administrative interface;
at least one network interface; and
at least one processor communicatively coupled with the administrative interface and the network interface, wherein the device server receives via an administrative interface values for predefined display parameters for each of a multiple of web feeds, wherein the device server under control of the processor creates a display template for each of the multiple of web feeds using the values received for the respective web feeds, wherein the device server receives via a network interface a subscription request for one of the web feeds from a device, wherein the device server receives via a network interface items in the requested one of the web feeds in response to the subscription request, wherein the device server under control of the processor creates web pages containing the items using the display template for the requested one of the web feeds and wherein the device server transmits via a network interface the created web pages to the device.

19. The device server of claim 18, wherein the device server under control of the processor creates a top page containing a selectable subscription icon for each of the multiple of web feeds using the display templates and transmits via a network interface the top page to the device, and wherein the subscription request is received in response to selection on the device of one of the subscription icons.

20. The device server of claim 18, wherein the device is an embedded device.
